(19) United States
(12) Patent Application Publication
(10) Pub. No.: US 2012/0144171 A1
(43) Pub. Date: Jun. 7, 2012

(54) Mechanism for Detection and Measurement of Hardware-Based Processor Latency

(76) Inventors: Jonathan Masters, Cambridge, MA (US); Steven D. Rostedt, Endwell, NY (US)

(21) Appl. No.: 12/962,453

(22) Filed: Dec. 7, 2010

(51) Int. Cl. G06F 9/30

(52) U.S. Cl. 712/227; 712/E09.032

(57) ABSTRACT

A mechanism for detection and measurement of hardware-based processor latency is disclosed. A method of the invention includes issuing an instruction to stop all running instructions on one or more processors of a multi-core computing device, starting a latency measurement code loop on each of the one or more processors, wherein for each of the one or more processors the latency measurement code loop operates to sample a time stamp counter (TSC) for a first time reading and sample the TSC for a second time reading after a predetermined period of time, and determine whether a difference between the first and the second time readings represents a discontinuous time interval where an operating system (OS) of the computing device does not control the one or more processors.

### TECHNICAL FIELD

The embodiments of the invention relate generally to latency in processors and, more specifically, relate to a mechanism for detection and measurement of hardware-based processor latency.

### BACKGROUND

In a real-time product, delivering timely responses and results is of the utmost importance. Real-time systems are specifically designed to be low-latency. They rely on an operating system (OS) that can meet specific time and determinism requirements. The OS, in turn, relies on a quick and responsive processor to meet these time and determinism requirements.

However, a problem arises in a real-time product, when a system vendor tries to save resources (i.e., money) by periodically stealing the processor away from the OS and using the processor to run low-level system code, such as a system management task. For example, a system vendor may utilize system management interrupts (SMIs) to run code for fixing hardware bugs, workarounds, and many other features. While most SMIs are very short running, it is the accumulation of many SMIs running many times per second that can create unacceptable latencies in the processor.

The above-described situation stops the OS from running and disrupts the OS' ability to deliver timely results. Current real-time products have not been able to determine when this is occurring or how to easily measure its occurrence.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 is a block diagram of a computing device capable of implementing embodiments of the invention;

FIG. 2 is a flow diagram illustrating a method for detection and measurement of hardware-based processor latency according to an embodiment of the invention; and

FIG. 3 illustrates a block diagram of one embodiment of a computer system.

### DETAILED DESCRIPTION

Embodiments of the invention provide a mechanism for detection and measurement of hardware-based processor latency. A method of embodiments of the invention includes issuing an instruction to stop all running instructions on one or more processors of a multi-core computing device, starting a latency measurement code loop on each of the one or more processors, wherein for each of the one or more processors the latency measurement code loop operates to sample a time stamp counter (TSC) for a first time reading and sample the TSC for a second time reading after a predetermined period of time, and determine whether a difference between the first and the second time readings represents a discontinuous time interval where an operating system (OS) of the computing device does not control the one or more processors.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending”, “receiving”, “attaching”, “forwarding”, “caching”, “issuing”, “starting”, “determining”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a machine readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

Embodiments of the invention provide a mechanism for detection and measurement of hardware-based processor latency. Essentially, embodiments of the invention operate in multi-core systems to periodically stop one or more CPUs from being used by the OS, while allowing other CPUs to continue running. Subsequently, one or more hardware counters are sampled to look for periods of unaccountable time in which the stopped one or more CPU may have been used by firmware, hypervisor, or other system vendor-supplied code. Embodiments of the invention can be used to detect the presence of SMIs, buggy BIOS code, or hypervisors, for example, and also to detect latency problems with real-time systems. Embodiments of the invention are able to measure latency without completely halting system execution.

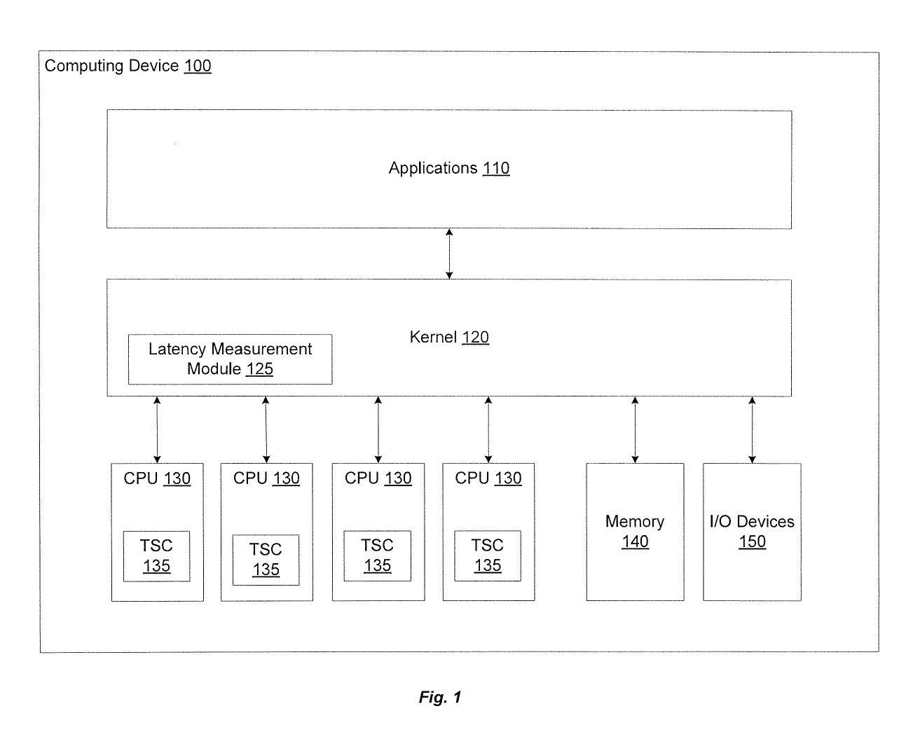

FIG. 1 is a block diagram of a multi-core computing device 100 capable of implementing embodiments of the invention. Multi-core computing device 100 includes one or more applications 100, a kernel 120 that is a key component of an OS (not shown) of computing device 100, a plurality of CPUs 130, memory 140, and I/O devices 150.

The kernel 120 is the central component of most OSs as it is a bridge between the applications 110 and the actual data processing done at the hardware level 130-150. The kernel's 120 responsibilities include managing the system's resources (the communication between hardware and software components). The kernel 120 can provide the lowest-level abstraction layer for the resources (especially processors 130 and I/O devices 150) that application software 110 must control to perform its function. It typically makes these facilities 130-150 available to application processes 110 through inter-process communication mechanisms and system calls.

In embodiments of the invention, as illustrated, kernel 120 includes a latency measurement module 125. Latency measurement module 125 is a loadable driver that enables a process to detect otherwise undetectable latencies not caused by the OS, typically caused by hardware or system firmware. Latency measurement module 125 provides a brute-force way to determine when one or more of the CPUs 130 is being stolen from the OS by stopping all other OS tasks and taking readings from one or more system timers 135 of the CPUs to ascertain if there are any discontinuous and unaccounted-for time periods occurring. If such discontinuous readings of the system timer occur, then latency measurement module 125 can positively conclude that during that time interval the OS was not in control of the one or more CPUs 130 and something else was controlling the CPUs 130.

Specifically, the latency measurement module 125 of kernel 120 exposes a software interface that allows parameters to be entered into the module 125 to dictate measurements such as a time interval size for selectively pausing the OS and a time interval period during which time counters are sampled by the module 125. In one embodiment, a subset of or all of the CPUs 130 may be stopped by the latency measurement model 125. In order to stop a CPU 130 of the multi-core device 100 to take measurements of the counters 135, the latency measurement model 125 may utilize an OS-provided routine called StopMachine, which when executed stops everything else from running on the CPU 130, in order to run a supplied function. The StopMachine functions is usually only used for loading drivers into the kernel 120, but in embodiments of the invention it may be utilized to stop the CPU 130 in order to run a code loop that samples time counters in the system. In some embodiments, the latency measurement module 125 stops the CPU 1-2 times per second and then samples one or more time counters many times over this time period to determine if there are any unaccounted-for, discontinuous time periods from these samples. In some embodiments, if a discontinuous time interval exceeds a threshold amount, then that will trigger the determination that a third-party vendor (e.g., using an SMI) is running on the system and stealing precious CPU resources.

As mentioned above, latency measurement module 125 stops a subset of or all of the CPUs 130 to sample one or more hardware counters in order to determine whether the CPUs 130 are being used by sources outside of the OS. Generally, a computing device includes various system time counters that increment even in the face of third-party vendor code running. Embodiments of the invention analyze these timestamps of these system time counters to determine if they have been incrementing. In one embodiment, the time stamp counter (TSC) 135 of each stopped CPU 130 is sampled by the latency measurement module 125 as part of the code it runs. The TSC 135 increments every time it performs a new instruction.

If it is determined that something outside of the OS is utilizing the CPU 130, then embodiments of the invention may determine what the “something else” is that is taking over the CPU 130. For instance, there are ways to programmatically determine if things like SMIs are turned on. In the chipset, there are registers that can be read to see if SMIs, in general, are enabled and could run. There are also undocumented registers in chipset that are used by BIOS or firmware vendor for SMI implementation that will have counters of their own. For example, with Intel™-based systems using the Intel LPC chipset controller, there is a global SMI enabled register that indicates whether SMIs will be delivered, and also several other registers that determine which kinds. Intel processors enter into a special System Management Mode when receiving SMIs that have an entirely different set of memory available for the BIOS code to store data in that is not normally visible to the OS. Lastly, an inspection of the configuration may lead to a potential cause of the takeover.

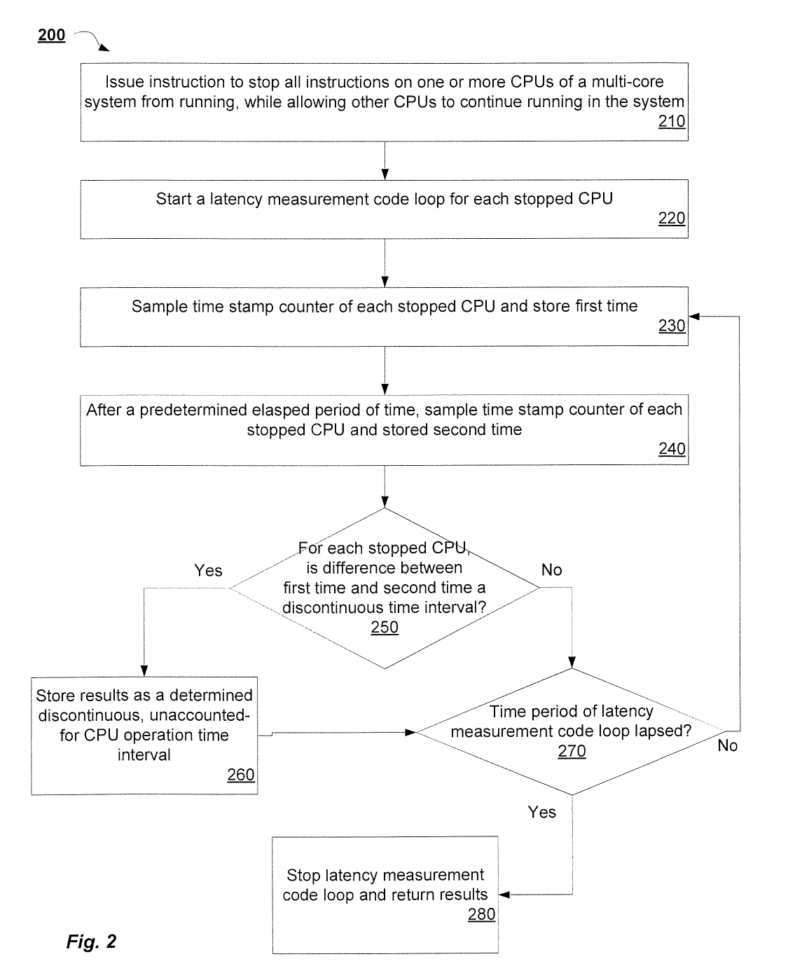

FIG. 2 is a flow diagram illustrating a method 200 for detection and measurement of hardware-based processor latency according to an embodiment of the invention. Method 200 may be performed by processing logic that may comprise hardware (e.g., circuitry, dedicated logic, programmable logic, microcode, etc.), software (such as instructions run on a processing device), firmware, or a combination thereof. In one embodiment, method 200 is performed by latency measurement module 125 of FIG. 1.

Method 200 begins at block 210 where an instruction is issued to stop all instructions from running on one or more CPUs of a multi-core system., while allowing other CPUs in the system to continue running. In one embodiment, a StopMachine instruction may be issued to accomplish stopping all instructions on the one or more CPUs. Then, at block 220, a latency measurement code loop is started on each of the stopped one or more CPUs. For each stopped CPU, the latency measurement code loop samples a time stamp counter in the system and stores the reading as a first time reading at block 230. Then, at block 240, after a predetermined elapsed period of time, the time stamp counter of each stopped CPU is read again and the reading stored as a second time reading. In some embodiments, the time stamp counter is the TSC of the CPU itself. Other embodiments envision that other time stamp counters in the computing system may be utilized, and more than one counter may be read at a time.

Subsequently, at decision block 250, for each stopped CPU, it is determined whether the difference between the first and second time readings represents a discontinuous time interval. In one embodiment, the amount of discontinuity between the readings should pass a threshold amount before triggering a determination of discontinuity. In other embodiments, any discontinuous reading may trigger the determination. If the difference between the time readings is not a discontinuous time interval, the method 200 proceeds to block 270.

However, if the difference between the time readings is a discontinuous time interval, then the results are stored as a determined discontinuous, unaccounted-for CPU operation time interval at block 260, and then the method 200 proceeds to block 270. In one embodiment, the results are stored in a global kernel-based table of results that is exposed to analysis software that is provided using a standard interface. The values present are raw times that are read by this analysis component.

At decision block 270, it is determined whether the time period of the latency measurement loop is over. In embodiments of the invention, the time periods for both of the latency measurement loop, as well as the time periods between TSC samples is predetermined by an end user of the latency measurement module. In some embodiments, a software interface may be presented to an end user allowing them to specify these time periods. In other embodiments, a default time period amount is utilized by the module.

If the time period of the latency measurement code loop has not lapsed at decision block 280, then the method 200 returns to block 230 to continue sampling and storing counter readings. On the other hand, if the time period of the latency measurement code loop has lapsed, then method 200 proceeds to block 280 to stop the latency measurement code loop and return the results of any discontinuous time intervals it has detected for further analysis.

In some embodiments, the results are returned using a system kernel interface, and values are output in terms of a timestamp (when the value was sampled) and a second value indicating how long the discontiguous period lasted from that timestamp. The results data interface appears as a file that is dynamically generated when it is read by the kernel, which reads from its internal tables of results it has stored. The results stored are kept in a data structure (ringbuffer) that can store a large number of entries and may dynamically increase in size to store more entries if needed.

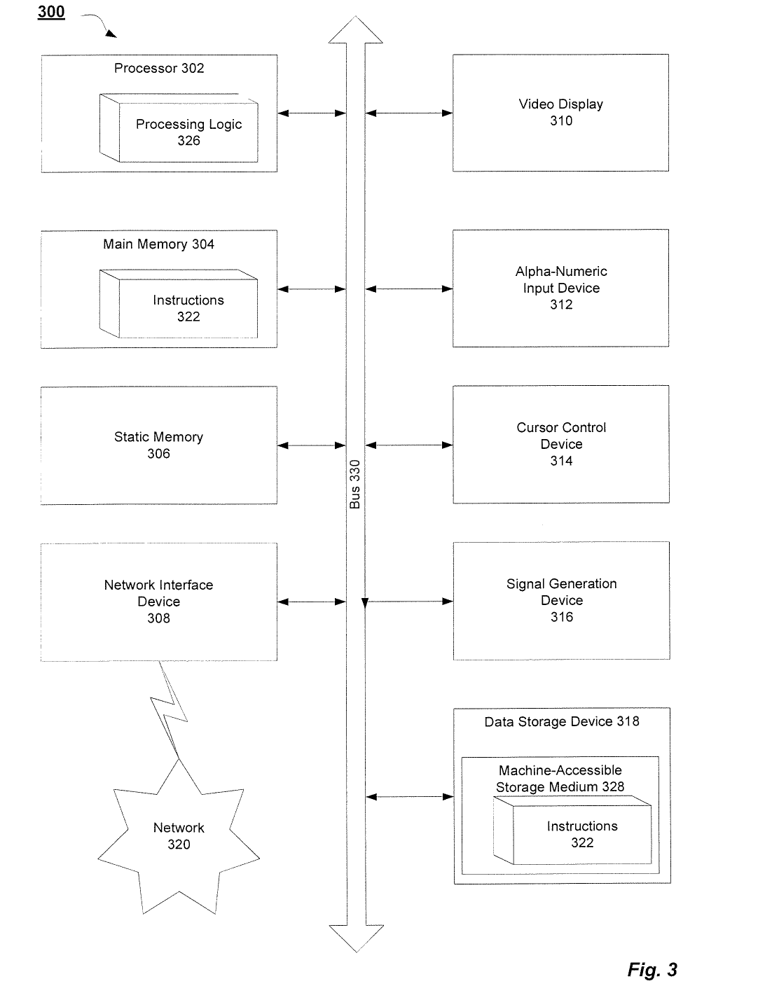

FIG. 3 illustrates a diagrammatic representation of a machine in the exemplary form of a computer system 300 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processing device 302, a main memory 304 (e.g., read-only memory (ROM), flash memory, dynamic random access memory (DRAM) (such as synchronous DRAM (SDRAM) or Rambus DRAM (RDRAM), etc.), a static memory 306 (e.g., flash memory, static random access memory (SRAM), etc.), and a data storage device 318, which communicate with each other via a bus 330.

Processing device 302 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 302 may also be one or more special-purpose processing devices such as an application specific integrated circuit (ASIC), a field programmable gate array (FPGA), a digital signal processor (DSP), network processor, or the like. The processing device 302 is configured to execute the processing logic 326 for performing the operations and steps discussed herein.

The computer system 300 may further include a network interface device 308. The computer system 300 also may include a video display unit 310 (e.g., a liquid crystal display (LCD) or a cathode ray tube (CRT)), an alphanumeric input device 312 (e.g., a keyboard), a cursor control device 314 (e.g., a mouse), and a signal generation device 316 (e.g., a speaker).

The data storage device 318 may include a machine-accessible storage medium 328 on which is stored one or more set of instructions (e.g., software 322) embodying any one or more of the methodologies of functions described herein. For example, software 322 may store instructions to perform a detection and measurement of hardware-based processor latency by latency measurement module 125 described with respect to FIG. 1. The software 322 may also reside, completely or at least partially, within the main memory 304 and/or within the processing device 302 during execution thereof by the computer system 300; the main memory 304 and the processing device 302 also constituting machine-accessible storage media. The software 322 may further be transmitted or received over a network 320 via the network interface device 308.

The machine-readable storage medium 328 may also be used to store instructions to perform method 200 for detection and measurement of hardware-based processor latency described with respect to FIG. 2, and/or a software library containing methods that call the above applications. While the machine-accessible storage medium 328 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A computer-implemented method, comprising:
issuing, by a latency measurement module of a multi-core computing device, an instruction to stop all running instructions on one or more processors of the multi-core computing device;
starting, by the latency measurement module, a latency measurement code loop on each of the stopped one or more processors, wherein the latency measurement code loop operates to:
sample a time stamp counter (TSC) for a first time reading; and
sample the TSC for a second time reading after a predetermined period of time; and
determining, by the latency measurement module, whether a difference between the first and the second time readings represents a discontinuous time interval where an operating system (OS) of the computing device does not control the one or more processors.

2. The method of claim 1, wherein the TSC is a hardware counter of the processor.

3. The method of claim 1, wherein the latency measurement code loops samples the TSC for first and second time readings periodically over another predetermined period of time.

4. The method of claim 1, wherein the instruction to stop all running instructions on the processor is a StopMachine instruction.

5. The method of claim 1, wherein the latency measurement module is a loadable driver in a kernel of the OS.

6. The method of claim 1, wherein the predetermined period of time and the another predetermined period of time are set by an end user of the latency measurement module via a software interface of the latency measurement module.

7. The method of claim 1, wherein the discontinuous time interval is the result of a system management interrupt (SMI) issued to the processor by a system vendor of the computing device.

8. The method of claim 1, wherein the discontinuous time interval is the result of a utilization of the processor by a hypervisor of the computing device.

9. A system, comprising:
a plurality of processors;
a plurality of time stamp counters (TSC) each associated with a processor of the plurality of processors; and
a latency measurement module communicably coupled to the plurality of processors, the latency measurement module configured to:
issue an instruction to stop all running instructions on one or more of the plurality of processors;
start a latency measurement code loop on each of the stopped one or more processors, wherein the latency measurement code loop operates to:
sample the TSC for a first time reading; and
sample the TSC for a second time reading after a predetermined period of time; and
determine whether a difference between the first and the second time readings represents a discontinuous time interval where an operating system (OS) of the system does not control the one or more processors.

10. The system of claim 9, wherein the TSC is a hardware counter of the processor.

11. The system of claim 9, wherein the latency measurement code loops samples the TSC for first and second time readings periodically over another predetermined period of time.

12. The system of claim 9, wherein the instruction to stop all running instructions on the processor is a StopMachine instruction.

13. The system of claim 9, wherein the latency measurement module is a loadable driver in a kernel of the OS.

14. The system of claim 9, wherein the predetermined period of time and the another predetermined period of time are set by an end user of the latency measurement module via a software interface of the latency measurement module.

15. The system of claim 9, wherein the discontinuous time interval is the result of a system management interrupt (SMI) issued to the processor by a system vendor of the computing device.

16. An article of manufacture comprising a machine-readable storage medium including data that, when accessed by a machine, cause the machine to perform operations comprising:
issuing an instruction to stop all running instructions on one or more processors of a multi-core computing device;
starting a latency measurement code loop on each of the stopped one or more processors, wherein the latency measurement code loop operates to:
sample a time stamp counter (TSC) for a first time reading; and
sample the TSC for a second time reading after a predetermined period of time; and
determining whether a difference between the first and the second time readings represents a discontinuous time interval where an operating system (OS) of the computing device does not control the one or more processors.

17. The article of manufacture of claim 16, wherein the TSC is a hardware counter of the processor.

18. The article of manufacture of claim 16, wherein the latency measurement code loops samples the TSC for first and second time readings periodically over another predetermined period of time.

19. The article of manufacture of claim 16, wherein the instruction to stop all running instructions on the processor is a StopMachine instruction.

20. The article of manufacture of claim 16, wherein the discontinuous time interval is the result of a system management interrupt (SMI) issued to the processor by a system vendor of the computing device.
